(19) United States
(12) Patent Application Publication
(10) Pub. No.: US 2006/0007879 A1
(43) Pub. Date: Jan. 12, 2006

(54) Home agent

(75) Inventor: Naotoshi Watanabe, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/024,294

(22) Filed: Dec. 28, 2004

(30) Foreign Application Priority Data
Jul. 9, 2004 (JP) 2004-203677

(51) Int. Cl. H04Q 7/00

(52) U.S. Cl. 370/328

(57) ABSTRACT

A home agent is disclosed. The home agent holds binding information of a care of address of a mobile node and a home address of the mobile node, and transfers an IP packet having the home address as a destination address to the care of address, and the home agent includes a service switching part for switching services on the basis of a combination of a move destination of the mobile node and a correspondent node for the mobile node.

### BACKGROUND OF THE INVENTION

1. Field of the Invention

The present invention relates to a home agent. More particularly, the present invention relates to a home agent that stores binding information of a care of address (CoA) and a home address (HoA) of a mobile terminal, and that intercepts a packet sent from a communication partner terminal and transfers the packet to the care of address.

2. Description of the Related Art

In an IP (Internet Protocol) network, the mobile IPv4 (mobile Internet Protocol version 4) has been standardized by IETF (Internet Engineering Task Force) as a protocol that enables a terminal to continue communications even though the terminal moves between network areas. In addition, in recent years, a problem in that IP addresses may run out is getting worse due to a rapid increase of a number of terminals. Against this backdrop, efforts for shifting networks from IPv4 to IPv6 (Internet Protocol version 6) are taking off in recent years, in which IPv6 is a protocol that provides larger number of IP addresses. Thus, in addition to the mobile IP protocol based on IPv4, a mobile IP protocol based on IPv6 is being standardized as a protocol that supports mobility of terminals on an IPv6 network. IPv6 is subjected to deliberation in IETF to make RFCs for the IPv6.

In the mobile IPv6, a mobile terminal (to be referred to as MN: Mobile Node hereinafter) is associated with a home agent (HA) that manages movement of the mobile node. The home agent (HA) registers a care of address (CoA) of the mobile node. The care of address is an address assigned to the mobile node at a moved position that is out of a home link. After the care of address is registered in the home agent, when the mobile node further moves to another area, the mobile node sends a new care of address to the home agent, so that the home agent updates the care of address corresponding to the mobile node. The home agent relays a packet for the mobile node.

In the mobile IPv6, it is indispensable to use IPsec (IP Security Protocol) encryption. Generally, the process load for the IPsec encryption is larger than that of packet transferring or encapsulate/decapsulate processing, and generally, the higher the security level is, the heavier the load for the IPsec encryption is.

FIG. 1 is a block diagram showing an example of a conventional mobile IP system. In the figure, the mobile node 10 has a predetermined home address (HoA), and the mobile node 10 is usually connected to a home link 11 that is an intranet LAN and the like. A home agent (HA) 12 that is a router is connected to the home link 11. In addition, the home agent 12 is connected to a network 13 such as the Internet.

When the mobile node 10 moves to a foreign link 14, the home agent 12 obtains a binding cache (BC) that includes a pair of the care of address and the home address of the mobile node 10. In addition, the home agent 12 has an IP-in-IP encapsulating function for encapsulating an IP packet transferred from a communication partner terminal (to be referred to as CN: Correspondent Node hereinafter) to the home address of the mobile node and transferring the encapsulated IP packet to the care of address of the mobile node, so that the packet transferred from the correspondent node 15 can be relayed to the mobile node 10.

In Japanese Laid-Open Patent Application No. 10-126405, a mobile computer is disclosed, in which the mobile computer obtains and compares security policies of encryption gateways located in a home link and a foreign link so as to determine whether the encryption gateway of the foreign link can be used as an end point of an encrypted tunnel. If the encryption gateway of the foreign link cannot be used as the end point, the encryption gateway of the foreign link is set such that it passes through an encrypted tunnel flow, so that the mobile computer itself terminates the tunnel.

From now on, as mobile communications become widespread, it becomes necessary to insure different levels of security according to move destination areas or correspondent nodes requesting a communication. For example, in a case when a user travels on business to a group company and the user receives a VoIP (Voice over IP) call from the user's section at the group company via a network of the group company, it is necessary to encrypts the VoIP communication to prevent leakage of information.

Also, there is another method for processing data of communications other than the above-mentioned packet-by-packet encryption processing according to move destination areas or the like. For example, there is “reading right processing” for preventing a user from printing out (or copying) an electric document received by FTP (File Transfer Protocol) in a customer's company.

Other than the security service, it may be required to provide different services according to move destination areas or correspondent nodes requesting communications. Although a conventional home agent includes an encryption processing function, the conventional home agent does not include a function to change encryption levels according to a combination of a move destination area and a correspondent node for each mobile node.

In addition, the heavy load for encryption processing is a bottleneck in realizing scalability such as providing a large capacity home agent. This causes a problem for realizing the function to change encryption levels according to a combination of a move destination area and a correspondent node for each mobile node. That is, the heavy load for encryption processing causes a problem for applying an encryption algorithm of a strength suitable for insuring a necessary security level to perform encryption.

To provide a function of packet-by-packet encryption without using the home agent and to provide value added services, it can be considered to provide a specific server that has the function of packet-by-packet encryption and the function to provide the value added services. That is, an encryption gateway server or a reading right processing server is provided to encrypt communication information or to prevent leakage of electronic documents. In mobile communications using the mobile IP, by providing the encryption gateway server or the reading right processing server for relaying packets at a position indicated by a dotted line 16 in FIG. 1 between the home agent 12 and the foreign link 14, it is possible to provide the desired security level or the additional services.

However, each of the encryption gateway server and the reading right processing server requires an after-mentioned special processing overhead. Further, there is a problem in that transmission speed is decreased since all communication data are passed through the servers.

In a case where mobile communications based on mobile IP are performed, the home agent 12 intercepts a packet sent from the correspondent node 15 to the mobile node 10. The home agent 12 encapsulates the packet and transfers the encapsulated packet to the care of address of the mobile node 10 such that the correspondent node 15 does not need to know movement of the mobile node 10. A source address of the packet sent from the home agent 12 to the mobile node 10 is an address of the home agent 12. Thus, in the case when the encryption gateway server or the reading right processing server indicated by the dotted line 16 is provided between the home agent 12 and the mobile node 10 for performing processes according to move destination areas or correspondent nodes, it is necessary for each of the servers to read a destination address and a source address of a packet that is included in the encapsulated packet. Since the care of address is an address that is dynamically obtained in a move destination, the care of address cannot be used as a key for determining a proper security policy.

The above-mentioned process is an additional process for the encryption gateway server or the reading right processing server, and causes a process overhead so that transferring performance may degrade. In addition, there may be a case in which the processing in the server is not necessary according to a move destination area or a correspondent node. Even when the processing of the servers is unnecessary, since all packets are passed through and the processing is performed, the servers may become a bottleneck of communications.

### SUMMARY OF THE INVENTION

An object of the present invention is to provide a home agent that can switch services according to a combination of a move destination area and a corresponding node for each mobile node to prevent degradation of a data transfer rate.

The object is achieved by a home agent that holds binding information of a care of address and a home address of a mobile node, and that transfers, to the care of address, an IP packet sent to the home address, the home agent including:
a service switching part for switching services on the basis of a combination of a move destination of the mobile node and a correspondent node for the mobile node.

According to the present invention, services can be switched according to a combination of a move destination and a correspondent node so as to prevent degradation of data transfer rate.

The service switching part may include:
a transferring part for transferring an object packet of a specific service to an external apparatus; and
a receiving part for receiving the object packet on which a process relating to the specific service has been performed in the external apparatus. Accordingly, only the object packet of the specific service can be transferred to the external apparatus so that degradation of the data transfer rate can be avoided.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing an example of a conventional mobile IP system;

FIG. 2 is a block diagram of an embodiment of a mobile IP system according to the present invention;

FIG. 3 is a block diagram of a home agent according to a fist embodiment of the present invention;

FIG. 4 is a block diagram showing a home agent modified from one shown in FIG. 3;

FIGS. 5A-5D show configurations of tables in the home agent;

FIGS. 6A-6F show configurations of tables in a service management part;

FIG. 7 shows a sequence chart for generating an entry of encryption information;

FIG. 8 shows a sequence chart for switching external apparatuses;

FIG. 9 shows a sequence chart for providing an additional service;

FIG. 10 is a block diagram of the home agent according to a second embodiment of the present invention.

### DETAILED DESCRIPTION OF THE PREFERRED EMBODIMENTS

In the following, embodiments of the present invention are described with reference to figures.

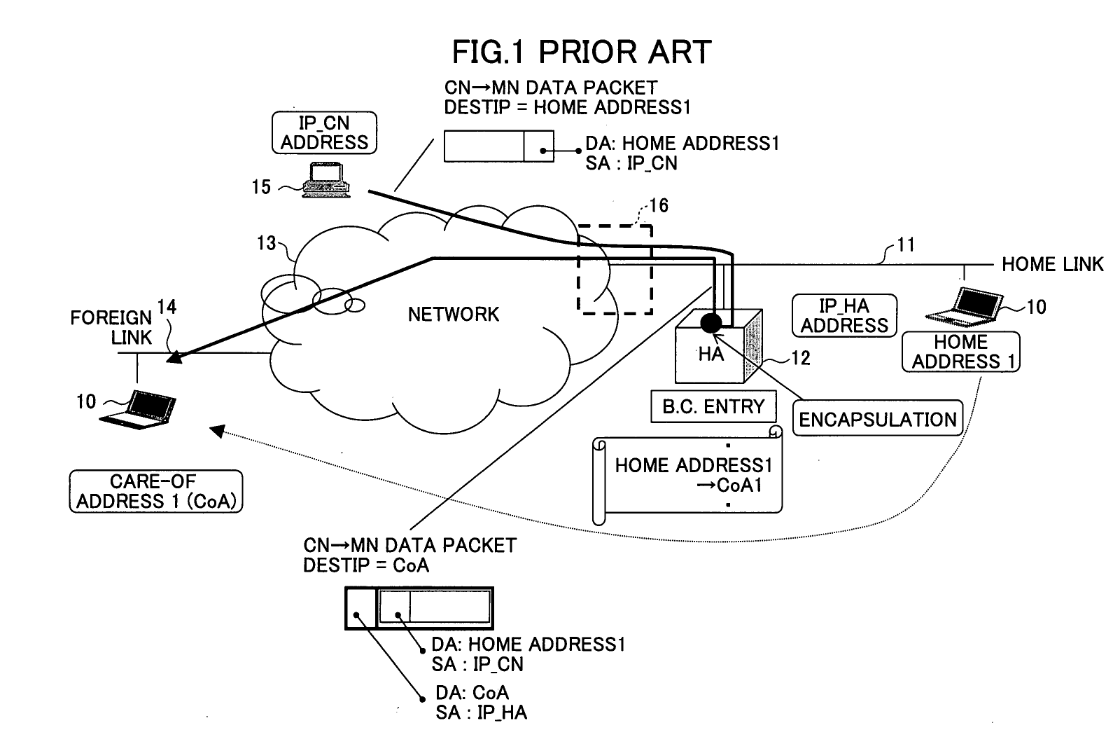

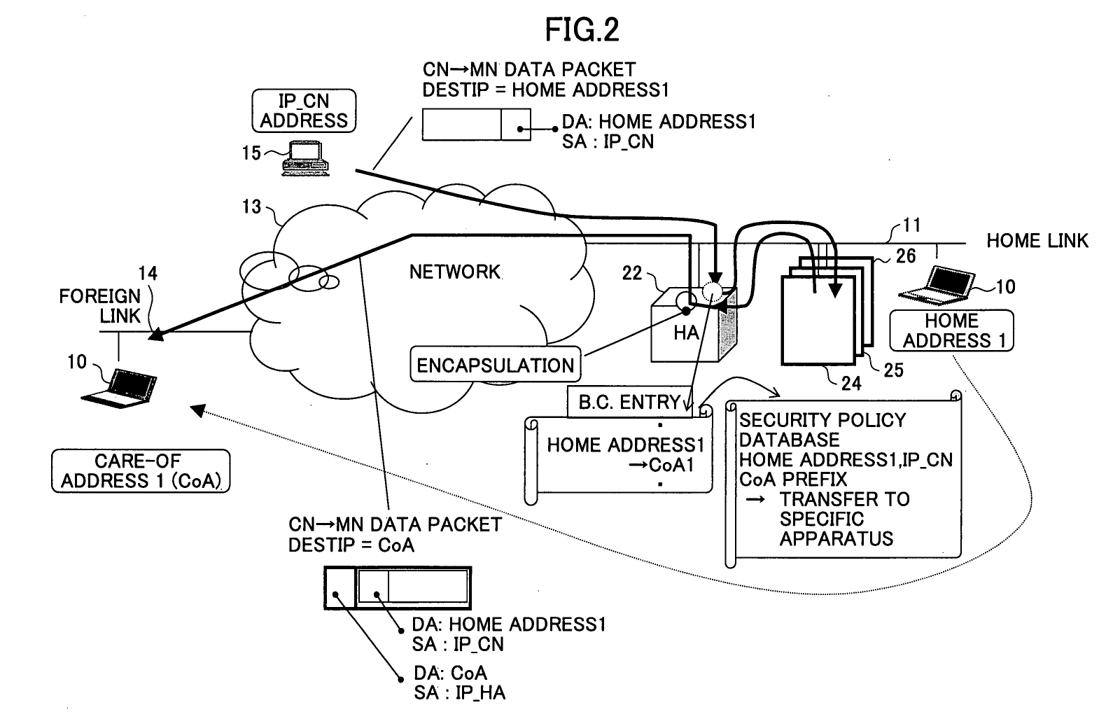

FIG. 2 is a block diagram of an embodiment of a mobile IP system according to the present invention. In the figure, the same reference numerals used in FIG. 1 are used to identify corresponding features in FIG. 2. In FIG. 2, the mobile node 10 has a predetermined home address (HoA), and the mobile node 10 is usually connected to a home link such as a LAN and the like in a head office. A home agent 22 that is a router is connected to the home link 11. In addition, the home agent 22 is connected to a network 13 such as the Internet.

The home agent 22 holds a biding cache (BC) that is a pair of the care of address and the home address of the mobile node 10 when the mobile node 10 moves to an foreign link 14 such a LAN in a branch office. In addition, the home agent 22 includes an IP-in-IP encapsulating function for encapsulating an IP packet transferred to the home address of the mobile node and transferring the encapsulating IP packet to the care of address, so that the packet is transferred from a correspondent node (CN) 15 to the mobile node 10.

In the present invention, a security policy is realized or a service is provided according to a foreign link and a correspondent node for the mobile node 10. For this purpose, functions in the encryption gateway server or the reading right processing server are not modified. Instead of that, a security policy database, for example, in the home agent 22 is extended so that only communications that require processing by the external apparatuses 24, 25, 26 such as the encryption gateway sever or the reading right processing server are transferred to the external apparatuses 24, 25, 26 based on policies in the security policy database. The external apparatuses are connected to the home link 11. Alternatively, the external apparatuses 24, 25 and 26 may be directly connected to the home agent 22 without passing through the home link 11. In addition, the number of the external apparatuses can be 1, 2, or more than 3.

A packet processed in an external apparatus returns to the home agent 22, and the home agent 22 performs regular mobile IP transferring processes. Accordingly, the external apparatus does not require adding additional functions such as a function for reading information in an encapsulated packet. In addition, any traffic that is not a process target does not pass through the external apparatus. Therefore, the bottleneck problem can be avoided. Further, since a general computer can be used as the external apparatus, a system can be constructed with low cost and services can be provided flexibly.

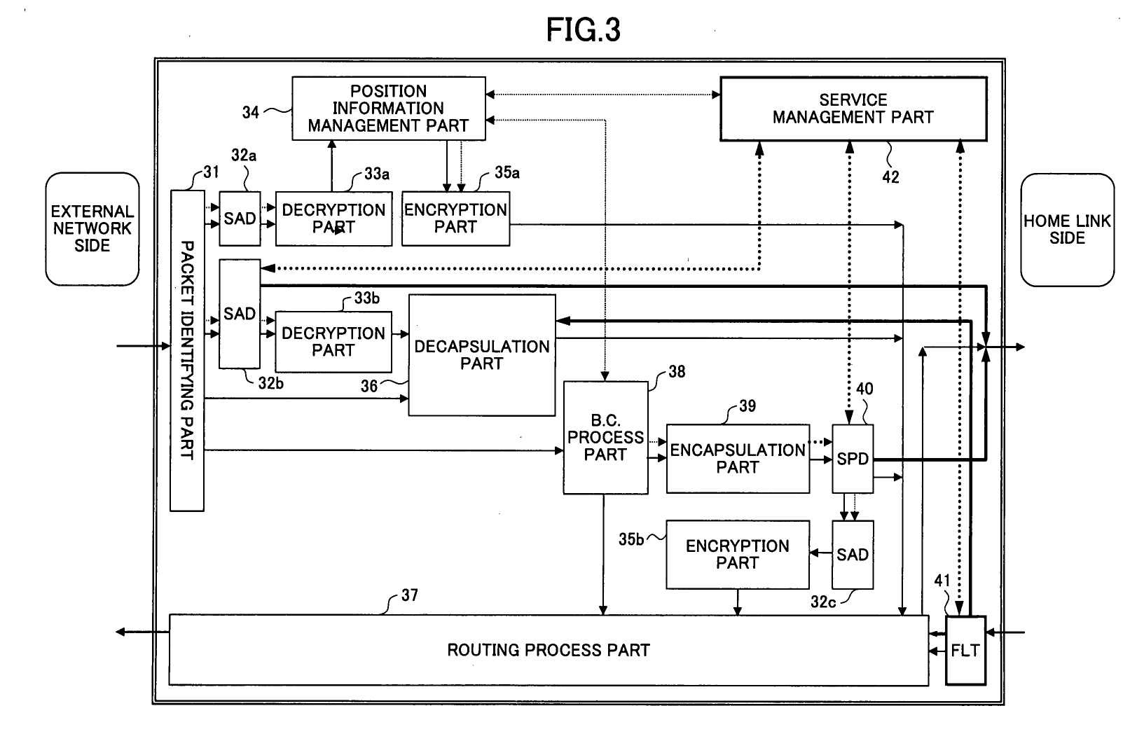

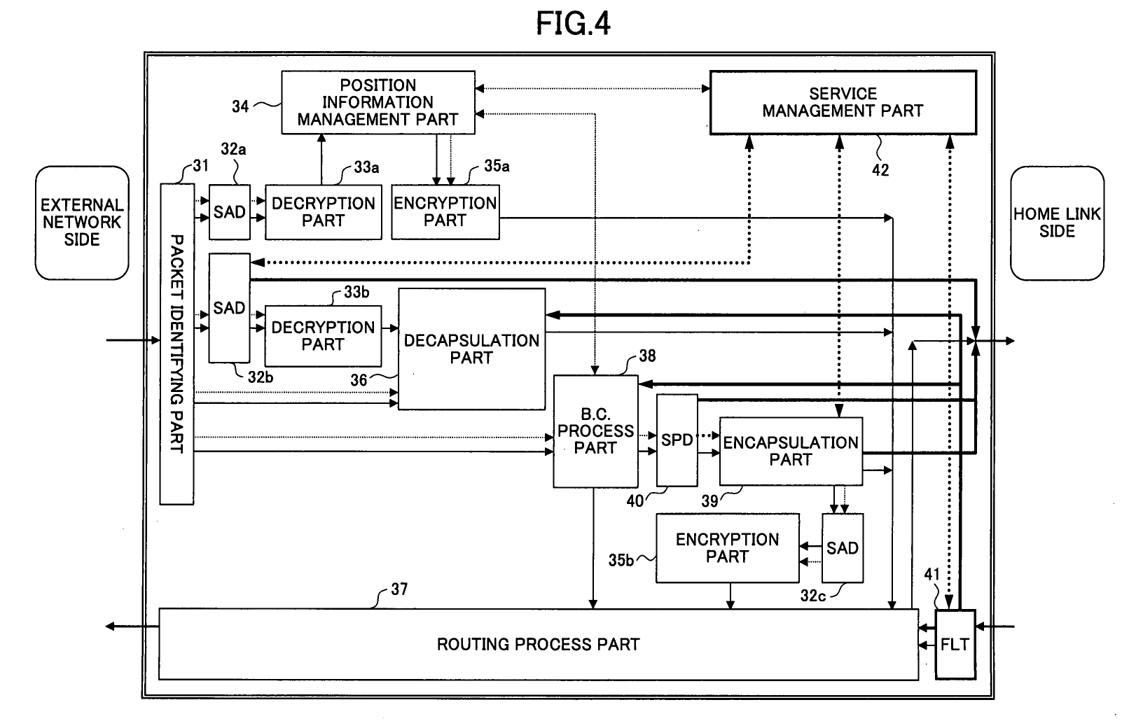

FIG. 3 is a block diagram of a home agent according to a fist embodiment of the present invention. FIG. 4 is a block diagram showing a home agent modified from one shown in FIG. 3. In FIGS. 3 and 4, an arrow with a solid line indicates a flow of packet data and an arrow with a dotted line indicates a flow of control data.

First, packet processing that does not require special security processing or additional service processing is described.

In FIG. 3, a packet received from the network 13 is provided to a packet identifying part 31 first, so that a next process is determined according to header information in the packet.

(1) In a case where the home agent 22 receives a position registration message (Binding Update message) from the mobile node 10

The packet identifying part 31 determines that the position registration message is received by identifying that the packet includes an address of the home agent 22 as a destination IP address and an optional header including information of the position registration message. After that, since the packet of the position registration message includes authentication data and is encrypted, a SAD part 32a extracts a SPI (Security Parameter Index) that is an identifier of SA (Security Association) that is a logical connection, searches a SAD (Security Association Database) in the SAD part 32a by using the SPI as a key, so as to obtain information necessary for decryption.

The SAD part 32a passes the information and the packet to a decryption part 33a to decrypt the packet. The decrypted packet is provided to a position information management part 34. The position information management part 34 extracts information necessary for position management, generates and updates management information. For example, if the mobile node 10 moves to a new area so that the mobile node 10 sends a care of address to the home agent 22, the home agent 22 holds a binding of the home address (HoA) and the care of address (CoA) of the mobile node 10. Further, to relay the packet from a correspondent node to the mobile node 10, a B.C. process part 38 stores the binding in a binding cache (B.C.) table in the B.C. process part 38.

After the position information management part 34 receives the position registration message and performs the above-mentioned necessary processes, the position information management part 34 generates a registration acknowledgement message (Binding Acknowledge:BA message) to the mobile node 10 that is the source of the message. The packet of the acknowledgement message is passed to an encryption part 35a with encryption execution information specified by the position information management part 34 so that the packet is encrypted. After the encryption, the packet is passed to a routing process part 37, and is transmitted from a network interface indicated by a forwarding table in the routing process part 37.

(2) In a case where the home agent 22 receives a packet sent to the home address (HoA) of the mobile node 10 from a correspondent node

The packet identifying part 31 determines that the packet is one sent to the home address of the mobile node 10 since the packet is not the packet of the position registration message and is not the IP-in-IP encapsulated packet. Then, the packet is passed to the B.C. process part 38. Then, the B.C. process part 38 extracts the destination address of the packet and searches the B.C. table by using the destination address as a key.

If there is no corresponding entry in the B.C. table, the B.C. process part 38 passes the packet to the routing process part 37 so that the packet is transmitted from a network interface indicated by information in the forwarding table. The fact that the destination address is HoA and that there is no entry in the B.C. table means that the mobile node 11 is not moved from the home link 11, so that the result of routing is a network interface connected to the home link 11.

If an entry exists in the B.C. table, since the mobile node 10 exists in a foreign link 14 and has a care of address, the B.C. process part 38 passes the packet to the encapsulating part 39 with the care of address obtained from the B.C. table. The encapsulating part 39 encapsulates the packet to generate an IP-in-IP encapsulated packet in which the destination address is the care of address and the address of the home agent is a source address. Then, the encapsulating part 39 passes the encapsulated packet to a SPD part 40.

The SPD part 40 extracts header information from the packet, and searches a SPD (Security Policy Database) by using the header information as a key. If there is no corresponding entry in the SPD, the SPD part 40 passes the packet to the routing process part 37 so that the packet is transmitted from a network interface indicated by information in the forwarding table.

If there is a corresponding entry in the SPD, the SPD part 40 passes the entry information to the SAD part 32c with the packet. The SAD part 32c selects a SA based on the entry information. Then, the SAD part 32c passes the packet to the encryption part 35c. After the encryption part 35b encrypts the packet, the encryption part 35b passes the packet to the routing process part 37, so that the packet is transmitted from a network interface indicated by information in the forwarding table. The destination address of the encrypted packet is the care of address, so that the packet is transferred to the mobile node 10 as a result of routing.

In the example shown in FIG. 4, when there is the entry in the B.C. table, the B.C. process part 38 passes the packet to the SPD part 40 with the care of address obtained from the B.C. table. The SPD part 40 extracts header information from the packet so as to search the SPD. If there is no entry in the SPD, the encapsulating part 39 encapsulates the packet to generate an IP-in-IP encapsulated packet and passes the packet to the routing process part 37. If there is an entry in the SPD, the packet with the entry information is passed to the encapsulating part 39 to generate an IP-in-IP encapsulated packet. Then, the packet and the entry information is passed to the SAD part 32c.

(3) In a case where the home agent 22 receives a packet sent to a correspondent node from the mobile node 10 having the care of address that resides in the foreign link 14

The packet identifying part 31 determines that the packet is sent for the correspondent node since the destination IP address is the address of the home agent 22, and the packet is an IP-in-IP encapsulated packet or an encrypted packet without an option header including information of the position registration message.

When the packet to the correspondent node is an IP-in-IP encapsulated packet, the packet is passed to the decapsulation part 36 to decapsulate the packet. Then, the packet is passed to the routing process part 37, and the packet is transmitted from a network interface indicated by the forwarding table in the routing process part 37.

When the packet identifying part 31 determines that the packet is an encrypted packet, the packet identifying part 31 passes the packet to the SAD part 32b. The SAD part 32b extracts a SPI in the packet, searches a SAD (Security Association Database) by using the SPI as a key so as to obtain information necessary for decoding. Then, the packet and the information are passed to the decoding part 33b to decoding the packet. The decoded packet is decapsulated in the decapsulation part 36. Then, the packet is transmitted from a network interface indicated by the forwarding table in the routing process part 37.

(4) In a case where the home agent 22 receives a packet from the home link 11

The received packet is passed to the routing process part 37, and the packet is transmitted from a network interface indicated by the forwarding table in the routing process part 37.

A conventional home agent also performs he above-mentioned operations that do not require any special security processes or additional service processes.

In the present invention, the home agent is configured such that services can be switched according to a combination of a move destination and a correspondent node for each mobile node. For realizing this feature, a filter (FLT) part 41 is added between the home link 11 and the routing process part 37. In addition, a route from the filter part 41 to the decapsulation part 36, a route from the SAD part 32b to an interface of the home link 11 and a route from the SPD part 40 to the interface of the home link 11 are provided. In addition, in the configuration shown in FIG. 4, a route from the filter part 41 to the B.C. process part 38 and a route from the encapsulation part 39 to the interface of the home link 11 are provided.

Further, the home agent 22 has distribution logic for distributing a packet to the routes so that the home agent 22 determines a service to be provided according to a combination of a move destination and a correspondent node for each mobile node, and requests an external apparatus to perform necessary processes according to the service. The service management part 42 is provided for performing management of the distribution logic and generation of distribution information. The service management part 42 provides the filter part 41, the SAD part 32b and the SPD part 40 with necessary instructions, and makes settings for the parts.

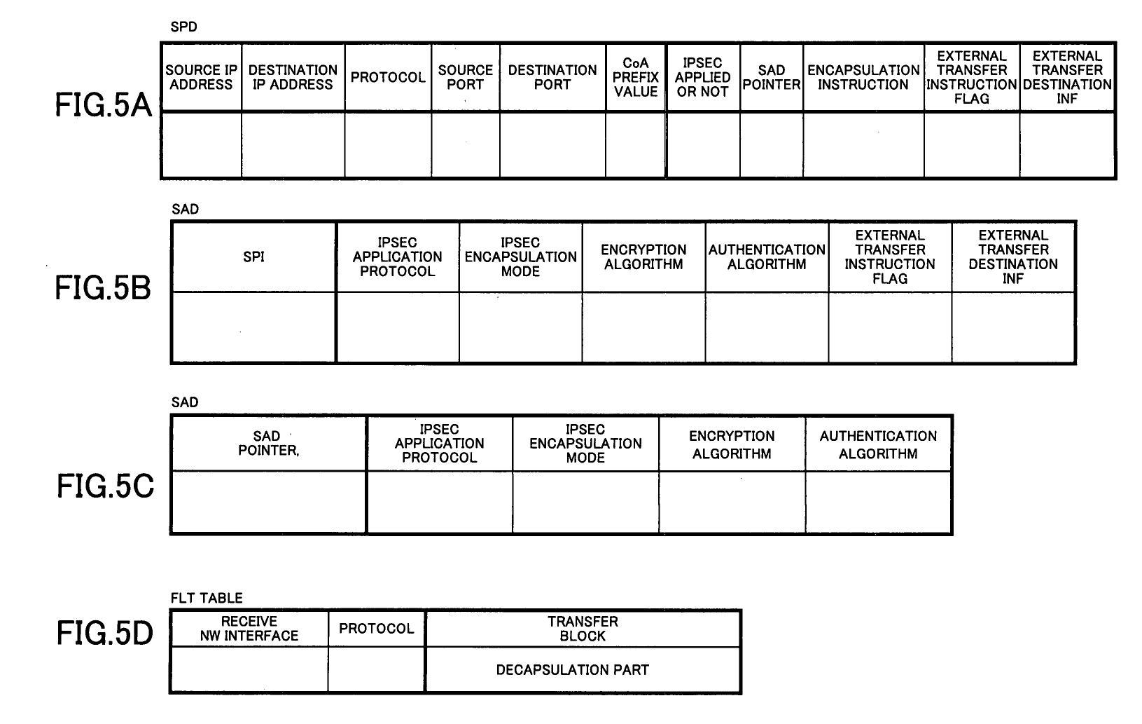

FIG. 5A shows a configuration of a database included in the SPD part 40. As shown in FIG. 5A, the database includes key items of “source IP address”, “destination IP address” and “protocol”, “source port”, and items of “destination port”, “CoA prefix value” (indicating a network in which a mobile node resides), “IPsec applied or not”, “SAD pointer”, “encapsulation instruction”, “external transfer instruction flag”, and “external transfer destination INF”.

FIG. 5B shows a configuration of a database included in the SAD part 32b. The database includes a key item of “SPI”, and items of “IPsec application protocol”, “IPsec encapsulation mode”, “encryption algorithm”, “authentication algorithm”, “external transfer instruction flag”, and “external transfer destination INF”. FIG. 5C shows a configuration of a database included in each of the SAD parts 32a and 32c. The database includes a key item of “SAD pointer” that is SPD entry information. In addition, the database includes “IPsec application protocol”, “IPsec encapsulation mode”, and “encryption algorithm”, and “authentication algorithm”.

FIG. 5D shows a configuration of a FLT table in the filter part 41. The database includes key items of “receive NW interface” and “protocol”. In addition, the database includes “transfer block” that is associated with the key items.

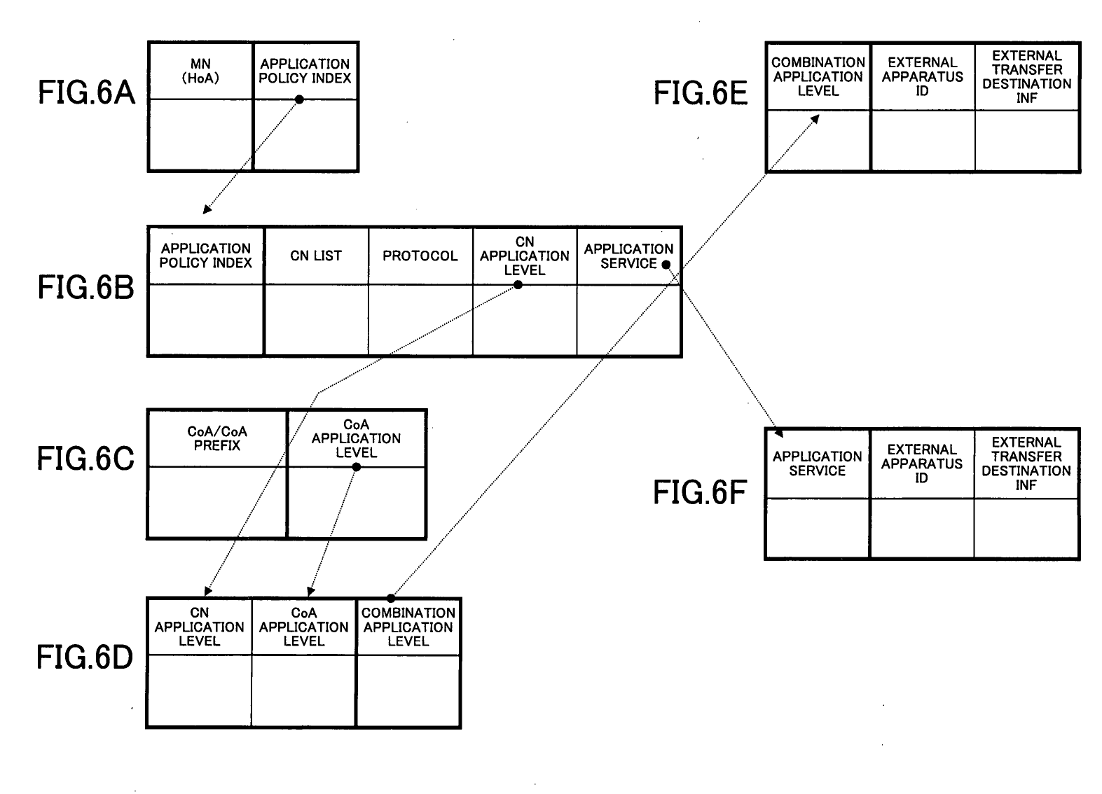

FIGS. 6A-F show configurations of tables in the service management part 42. As shown in FIG. 6A, “index of application policy” is set for each “home address” of mobile nodes. As shown in FIG. 6B, for “index of application policy”, “list of correspondent nodes” is set, and “protocol”, “CN application level” and “application service” are set for each correspondent node.

As shown in FIG. 6C, “CoA application level” is set for each care of address or prefix of care of address. In addition, as shown in FIG. 6D, “combination application level” is set for each pair of “CN application level” and “CoA application level”. As shown in FIG. 6E, “combination application level” is associated with “external apparatus ID” and “external transfer destination INF”. In addition, as shown in FIG. 6F, “application service” is associated with “external apparatus ID” and “external transfer destination interface”.

Instead of setting “application service” for each correspondent node corresponding to “index of the application policy” as shown in FIG. 6B, “application service” may be set with the “combination application level” for the “CN application level” and the “CoA application level”. In this case, application services can be switched according to a mobile node and a correspondent node.

In the following, operations for switching encryption levels according to a combination of a move destination and a correspondent node for each mobile node are described. The home agent 22 performs selection of an encryption level and performs encryption. For selecting the encryption level, each of the SAD part 32b and the SPD part 40 includes entries of encryption information (security policy) corresponding to each combination of a move destination and a correspondent node for each mobile node.

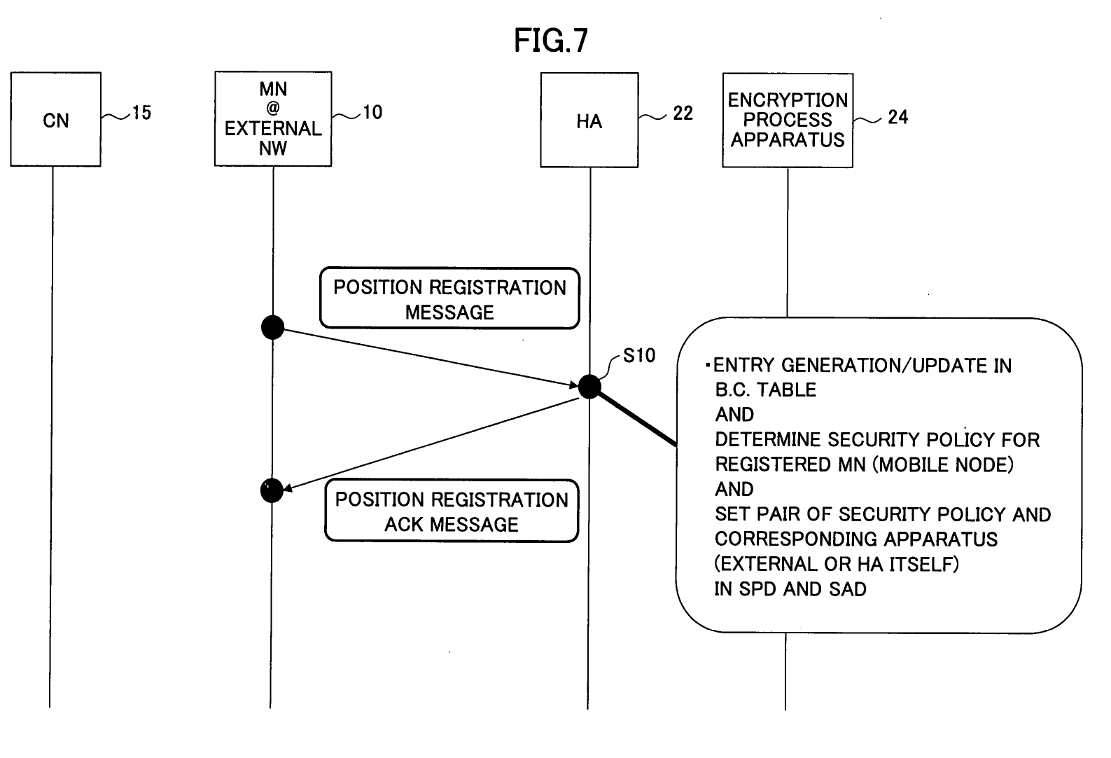

FIG. 7 shows a sequence chart for generating the entry of the encryption information. New registration or registration update of position information of the mobile node 10 in the foreign link 14 triggers the entry generation process. The mobile node 10 obtains its care of address in the foreign link 14, and sends the care of address to the home agent 22 by using the position registration message.

The service management part 42 in the home agent 22 has an information database including CN application levels for each correspondent node for each mobile node (FIGS. 6A and 6B) and including CoA application levels each corresponding to a prefix of a care of address (FIG. 6C). The CN application level is a security assuring level for a correspondent node corresponding to a mobile node. The CoA application level is a security assuring level of a foreign link corresponding to a prefix of a care of address.

When the home agent 22 receives a position registration message in step S10, the position registration message is sent to the position information registration management part 34 according to a procedure the same as conventional one. In addition to performing conventional processes including generation or update of B.C. table by using the notified care of address, the position information registration management part 34 sends information of the mobile node 10 and the care of address to the service management part 42 if the extracted care of address is new for the mobile node 10.

In response to receiving the information, the service management part 42 determines a combination application level as a security policy that should be applied to the combination of the correspondent node and the care of address by using the information database of the security assuring level. The determined combination application level is set in the SAD part 32a and the SPD part 40. That is, a security policy for a combination of a correspondent node and a care of address is determined from a security assuring level corresponding to the correspondent node and a security assuring level corresponding to the prefix of the care of address.

When the home agent 22 receives a packet sent from a correspondent node 15 to the mobile node 10 or a packet sent from the mobile node 10 to the correspondent node 15, the home agent 22 refers to the entry so as to select an encryption level that is the combination application level. Then, an instruction is sent to the encryption part 35b or the decoding part 33b according to the level.

If the selected combination application level is a predetermined level, the processing object packet is transferred to an external apparatus 24, for example, that is an external encryption process apparatus, so that the external apparatus 24 performs encryption processes. The above-mentioned procedure is a mechanism for causing the external apparatus 24 to perform a specific encryption process having heavy process load.

As shown in FIG. 6E, the service management part 42 has an external apparatus ID and an external transfer destination interface as information on apparatuses for performing the specific encryption process. The service management part 42 determines an application security policy corresponding to a combination of a correspondent node 15 and a care of address, and determines an apparatus (the home agent 22 itself or the external apparatus 24) that realizes the security policy. Then, the service management part 42 makes a setting for the SAD 32a and the SPD part 40.

Each of the SAD part 32a and the SPD part 40 refers to the setting information when receiving a packet. If there is a setting indicating that the packet should be transferred to the external apparatus 24, the packet is transferred to a designated external transfer destination interface.

When the home agent 22 receives a processed packet from the external apparatus 24, the home agent 22 performs a relay process for relaying the packet to the correspondent node 15 or the mobile node 10. For realizing this process, the filter part 41 determines whether the packet is for the correspondent node 15 or the mobile node 10 by identifying a receive interface by using the filter table shown in FIG. 5D, so that the filter part 41 distributes the packet to a proper process block.

For example, a packet received by a network interface to which the external apparatus 24 is not connected is passed to the routing process part 37 so that the packet is forwarded in the conventional way. When the packet is received by a receive network interface to which the external apparatus 24 is connected, if the packet is an IP-in-IP encapsulated packet, the home agent 22 determines that the packet is sent from the mobile node 10 to the correspondent node 15, so that the packet is passed to the decapsulating part 36. If the packet is an encrypted packet that is not encapsulated, the home agent 22 determines that the packet is a packet sent from the correspondent node 15 to the mobile node 10, so that the packet is passed to the routing process part 37 that forwards the packet based on information of the packet header.

An IPsec encryption mode performed in the external apparatus 24 is a transparent mode in which information other than the packet header in the packet is encrypted. As shown in FIG. 3, a packet sent from the correspondent node 15 to the mobile node 10 is encapsulated in the encapsulating part 39. After that, the packet is transferred to the external apparatus 24. The destination address in a packet header in the packet encrypted in the transparent mode by the external apparatus 24 is the care of address of the mobile node 10 that can be referred to by the routing process part 37. Thus, the routing process part 37 can forward the packet.

In the following, an embodiment is described in which external apparatuses are changed according to encryption levels. In this embodiment, a plurality of external apparatuses (external apparatuses 24 and 25, for example) that perform different encryption algorithms are used. The home agent 22 distributes a packet to a suitable external apparatus according to a required encryption process. This feature can be realized by increasing a number of entries of a table, in the service management part 42, storing correspondences of external apparatuses and connection interfaces. Accordingly, scalability can be realized for the encryption processes.

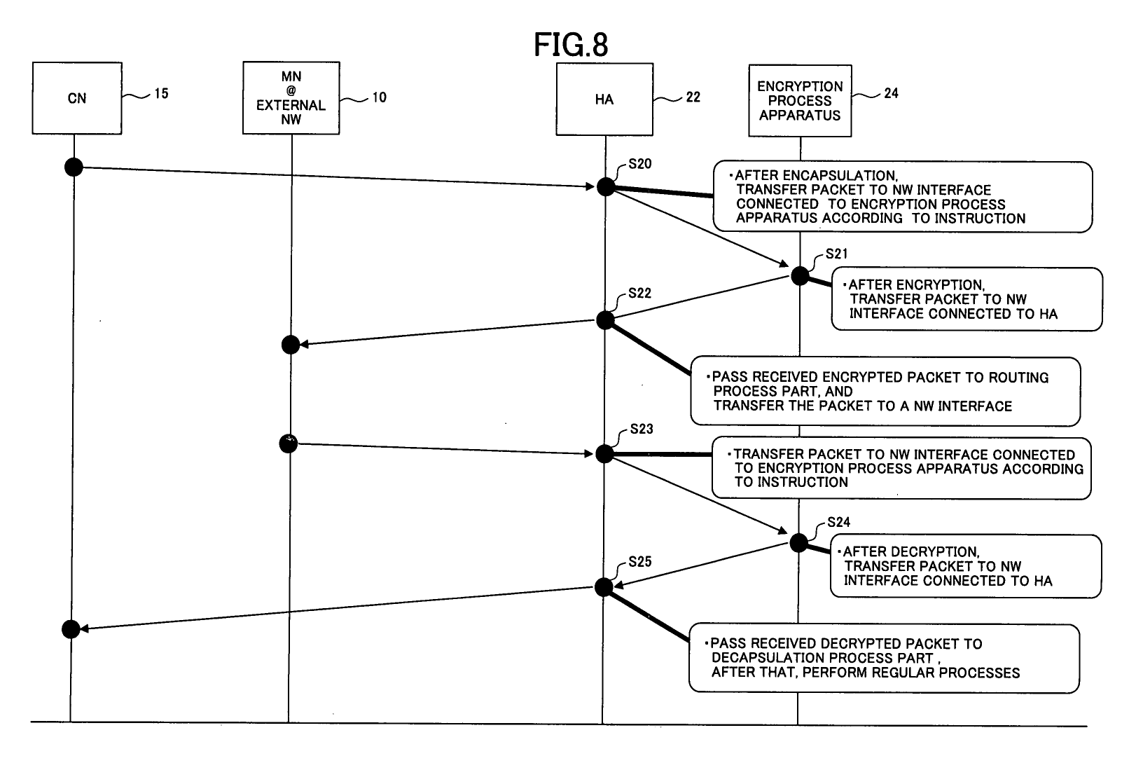

FIG. 8 shows a sequence of the process for switching external apparatuses. In the figure, when the home agent 22 receives a packet from the correspondent node 15 in step S20, the packet is encapsulated according to information of the B.C. table of the B.C. process part 38. After that, if there is a transfer instruction for transferring the packet to an external apparatus in the SPD of the SPD part 40, the packet is transferred to an external transfer destination interface to which the external apparatus is connected. In step S21, the external apparatus encrypts the packet according to SPD information in the external apparatus itself. After that, the external apparatus transfers the packet to a connection network interface connected to the home agent 22. In step S22, the home agent 22 receives the packet via a receive network interface, and recognizes that the packet is an encrypted packet. Then, the packet is passed to the routing process part 37, so that the home agent 22 forwards the packet to the mobile node 10 on the basis of information in the packet header.

In step S23, when the home agent 22 receives a packet from the mobile node 10, if there is a transfer instruction, in the SPD in the SPD 32b, to transfer the packet to an external apparatus, the home agent 22 transfers the packet to an external transfer destination interface to which the external apparatus is connected. In step S24, the external apparatus decodes the packet according to information in a SPD in the external apparatus. After that, the external apparatus transfers the packet to a connection network interface connected to the home agent 22. In step S25, the home agent 22 receives the packet via a receive network interface and identifies that the packet is not an encrypted packet. Then, the decapsulating part 36 decapsulates the packet, and the packet is passed to the routing process part 37 that forwards the packet to a correspondent node 15 according to information in the packet header.

The connection network interface may correspond to a physical interface or a logical interface which is one of multiplexed logical interfaces in a physical interface by using VLAN. By using the logical interface, a number of physical interfaces can be decreased in the home agent 22. Thus, the method of using the logical interface is effective when the home agent 22 needs to connect to a plurality of encryption process apparatuses.

Next, an embodiment is described in which the home agent 22 determines an additional service other than encryption so as to transfer a processing object packet to an external apparatus that performs the service. An example of the additional service is “reading restriction service” to prevent an electronic document received by using FTP in a customer's company from being printed out.

In this embodiment, the configuration of the home agent 22 is one shown in FIG. 4. Transfer routes from the SPD part 40 to the external apparatus 26 and from the encapsulating part 39 to the external apparatus 26 are provided. In addition, a transfer route is provided for transferring a packet received from the external apparatus 26 from the filter part 41 to the B.C. process part 38. The transfer routes are used for transferring a packet before encapsulation to the external apparatus 26, and for encapsulating the returned processed packet according to a service.

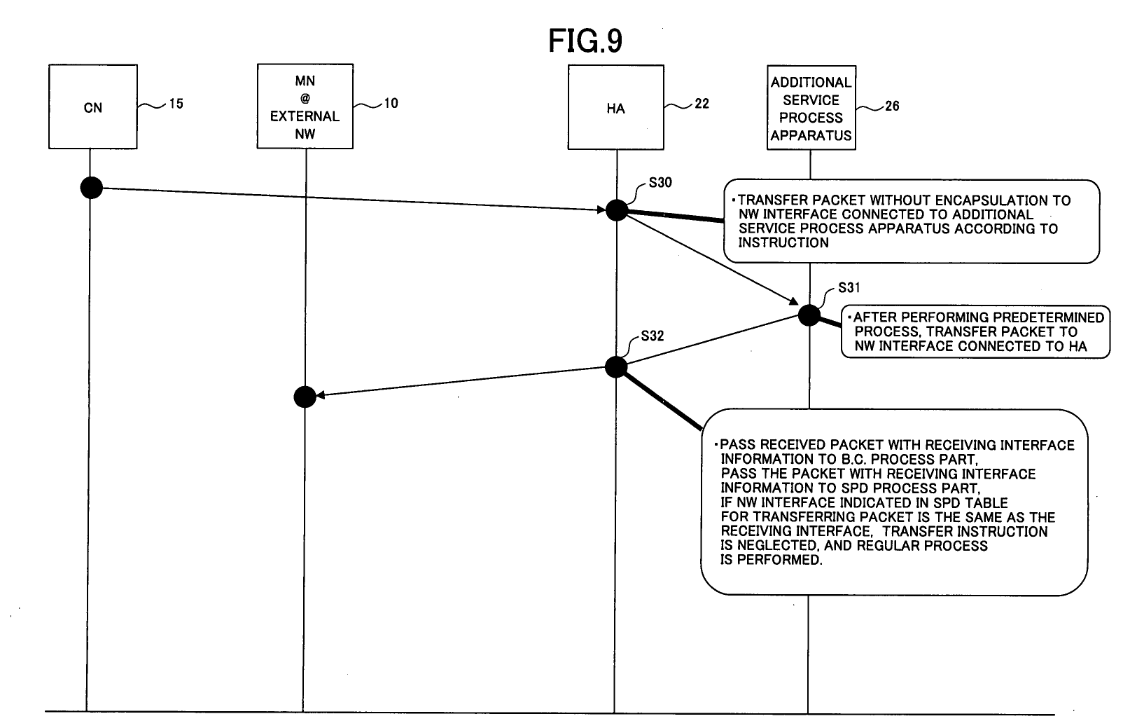

FIG. 9 shows a sequence chart for providing the additional service. As shown in the figure, in step S30, the home agent 22 receives a packet from the correspondent node 15. If there is a transfer instruction, in the SPD in the SPD part 40, for transferring the packet to the external apparatus 26, the home agent 22 transfers the packet to an external transfer destination interface to which the external apparatus 26 is connected without encapsulating the packet. In step S31, after the external apparatus 26 performs a predetermined process, the external apparatus 26 transfers the packet to a connection network interface of the home agent 22.

In step S32, the home agent 22 receives the packet via a receive network interface to which the external apparatus 26 is connected. The home agent 22 passes the packet to the B.C. process part 38 with the receive network interface information. The B.C. process part 38 performs a regular process and passes the packet and the receive network interface information to the SPD part 40. In the SPD part 40, if a network interface to which the SPD instructs to transfer the packet is the same as the receive network interface, the transfer instruction by the SPD is neglected, and the home agent 22 performs a regular process. That is, the encapsulating part 39 encapsulates the packet. Then, the packet is passed through the SAD part 32c and the encryption part 35b so that the packet is forwarded by the routing process part 37 based on information in the packet header to the mobile node 10. There may be a case where the packet does not pass through the SAD part 32c and the encryption part 35b according to the type of the packet.

A plurality of external apparatuses that provide additional services can be connected to the home agent 22 so that flexible combinations and configurations of the services can be provided.

Next, an embodiment is described in which the external apparatuses communicate with the mobile node 10 so as to dynamically exchange service performing information when encryption and additional services are provided.

In this embodiment, the home agent intercepts information exchanged between the external apparatuses and the mobile node 10 so as to obtain necessary information so that the information is shared by the home anent 22 and the external apparatuses.

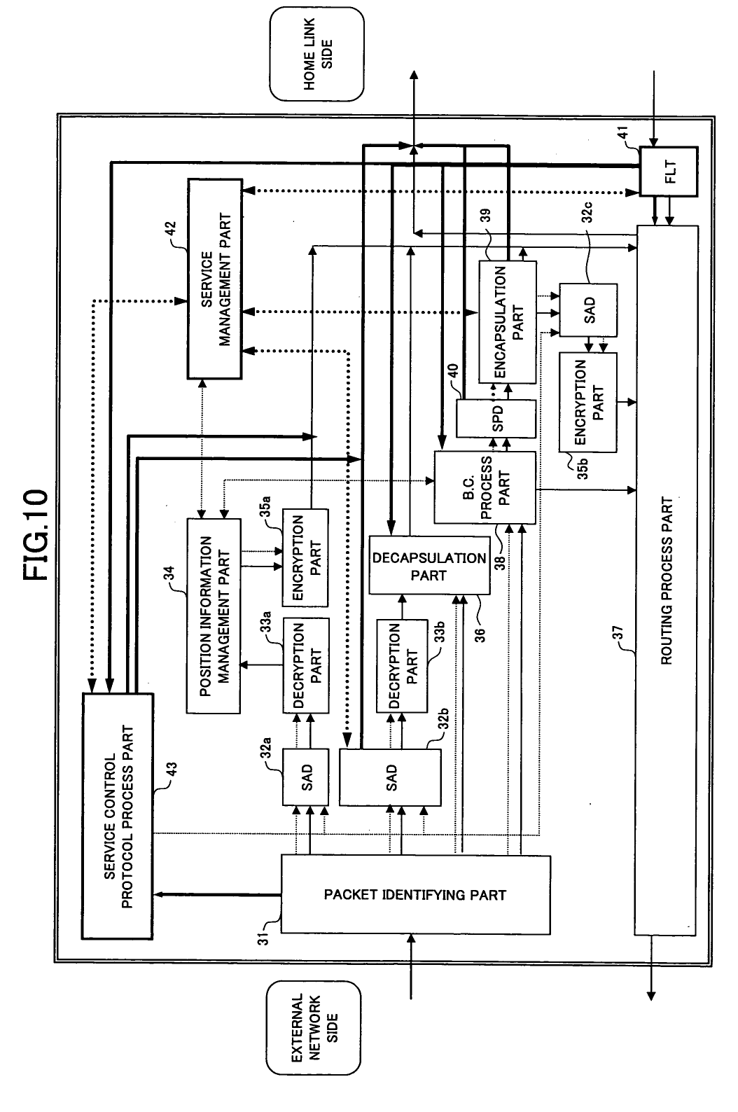

FIG. 10 is a block diagram of the home agent according to a second embodiment. In the figure, the same reference numerals have been used in FIG. 10 to identify corresponding features in FIG. 4. A different point between FIG. 10 and FIG. 4 is that a service control protocol process part 43 is provided in FIG. 10.

The home agent shown in FIG. 10 is configured such that an encrypted logical connection can be dynamically established between an external apparatus and the mobile node 10. The home agent 22 relays protocol data used for negotiation to an external apparatus. In the relaying process, the packet identifying part 31 intercepts information of encrypted logical connection and provides the information to the service control protocol process part 43, in which the information of encrypted logical connection are necessary for the SAD parts 32a, 32b and 32c and the information includes an IPsec application protocol, an IPsec encapsulating mode, an encryption algorithm and an authentication algorithm. Then, the service control protocol process part 43 holds the information and updates the IPsec application protocol, the IPsec encapsulating mode, the encryption algorithm and the authentication algorithm in the database in the SAD parts shown in FIGS. 5B and 5C.

The present invention is not limited to the specifically disclosed embodiments, and variations and modifications may be made without departing from the scope of the present invention.

The present application contains subject matter related to Japanese patent application No. 2004-203677, filed in the JPO on Jul. 9, 2004, the entire contents of which are incorporated herein by reference.

What is claimed is:

1. A home agent that holds binding information of a care of address and a home address of a mobile node, and that transfers, to the care of address, an IP packet sent to the home address, the home agent comprising:
a service switching part for switching services on the basis of a combination of a move destination of the mobile node and a correspondent node for the mobile node.

2. The home agent as claimed in claim 1, the service switching part comprising:
a transferring part for transferring an object packet of a specific service to an external apparatus; and
a receiving part for receiving the object packet on which a process relating to the specific service has been performed in the external apparatus.

3. The home agent as claimed in claim 2, wherein the specific service is to encrypt the object packet according to an encryption level corresponding to the combination.

4. The home agent as claimed in claim 3, wherein a plurality of external apparatuses are provided in which the external apparatuses correspond to a plurality of encryption levels, and the transferring part transfers the object packet to an external apparatus corresponding to the encryption level.

5. The home agent as claimed in claim 2, wherein the specific service is to perform a reading restriction process on the object packet.

6. The home agent as claimed in claim 2, wherein the external apparatus is connected to a home link of the home agent.

7. The home agent as claimed in claim 2, wherein the external apparatus is directly connected to the home agent.

8. The home agent as claimed in claim 1, the home agent further comprising:
an information obtaining part for obtaining execution information of the specific service when the mobile node and the external apparatus dynamically exchange the execution information of the specific service, and providing the service switching part with necessary information in the obtained execution information.
